(19) United States
(12) Patent Application Publication
(10) Pub. No.: US 2025/0132700 A1
(43) Pub. Date: Apr. 24, 2025

(54) MOTOR SYSTEM

(71) Applicant: Murata Machinery, Ltd., Kyoto-shi, Kyoto (JP)

(72) Inventors: Yoshiyuki Azuma, Inuyama-shi, Aichi (JP); Daisuke Fukushima, Inuyama-shi, Aichi (JP)

(73) Assignee: Murata Machinery, Ltd., Kyoto-shi, Kyoto (JP)

(21) Appl. No.: 18/724,482

(22) PCT Filed: Oct. 24, 2022
(86) PCT No.: PCT/JP2022/039594

§ 371 Date: Jan. 6, 2025

(30) Foreign Application Priority Data
Dec. 27, 2021 (JP) 2021-213559

(51) Int. Cl. H02P 5/74

(52) U.S. Cl. CPC H02P 5/74; H02P 2209/00

(57) ABSTRACT

In a motor system, a switcher selectively switches a target motor, which is a target to be supplied with electric power output by a motor driver and a target to be detected for a current by a current sensor, among a plurality of motors. The switcher cyclically switches the target motor among the plurality of motors. When the current of the target motor is detected by the current sensor, the motor driver is controlled to output the electric power based on a PWM duty ratio computed based on the current, at a timing when the motor in which the current is detected is again the target motor, in a cycle after the cycle in which the current is detected.

### CROSS-REFERENCE TO RELATED APPLICATIONS

This application is a US national stage filing under 35 U.S.C. § 371 of International Application No. PCT/JP2022/039594, filed Oct. 24, 2022, which claims priority to Japanese Patent Application No. 2021-213559, filed Dec. 27, 2021, each of which is incorporated herein by reference in its entirety.

### TECHNICAL FIELD

This disclosure relates to a motor system in which a motor driver drives a plurality of motors.

### BACKGROUND

Conventionally, there are known motor systems that distribute electric power output by a motor driver to a plurality of motors in a time-distributed manner. Japanese Patent Application Laid-Open 2007-288964 discloses that type of motor system.

In the motor driving apparatus disclosed in Japanese Patent Application Laid-Open 2007-288964, a plurality of motors are connected to only one motor driver via a switching circuitry. The motor driver controls turning-on/off of six transistors to apply an appropriate voltage to each of a U, V, and W phase drive coils provided by each motor. Each transistor is driven by a pulse signal using a pulse width modulation scheme. An appropriate operation of the switching circuitry allows simultaneous drive of the plurality of motors.

In Japanese Patent Application Laid-Open 2007-288964, it is not possible to individually control rotation speed and rotation direction of a plurality of motors that are driven simultaneously. To realize such control, a different sinusoidal current must be applied to each drive coil for each motor. However, near the timing at which the switching circuitry performs the switching, there is a risk that unintended outputs may be performed to the motors.

It could therefore be helpful to improve the control quality of each motor in a motor system in which electric power output by a motor driver is supplied to a plurality of motors while switching and driving the motors simultaneously.

### SUMMARY

We thus provide a motor system including a plurality of motors, a motor driver, a current detector, and a switcher. The motor driver outputs electric power to make the plurality of motors generate driving force. The current detector detects a current of the motor. The switcher selectively switches a target motor, which is a target to be supplied with the electric power output by the motor driver and a target to be detected for the current by the current detector, among the plurality of motors. A PWM duty ratio to drive the target motor is computed based on the current detected by the current detector. The motor driver is controlled to output the electric power based on the PWM duty ratio. The switcher cyclically switches the target motor among the plurality of motors. When the current of the target motor is detected by the current detector, the motor driver is controlled to output the electric power based on the PWM duty ratio computed based on the current, at a timing when the motor in which the current is detected is again the target motor in a cycle after the cycle in which the current is detected.

This allows one motor driver to drive the plurality of motors substantially simultaneously and control the output for each motor individually. The output of one motor driver can be cyclically switched among the plurality of motors while control to each motor can be correctly applied to the relevant motor. Since the motor driver and the current detector can be shared among the plurality of motors, the configuration can be simplified.

It is preferable that when the current of the target motor is detected by the current detector, the motor driver is controlled to output the electric power based on the PWM duty ratio computed based on the current, at a timing when the motor in which the current is detected is again the target motor in a cycle immediately following the cycle in which the current is detected.

This avoids controlling the target motor based on the detection value corresponding to a different motor.

It is preferable that when the current of the target motor is detected by the current detector, based on the current, a post-decay current is computed by a prediction of decay due to an electric power interruption period that occurs before the motor becomes the target motor again in the cycle immediately following the cycle in which the current is detected. The motor driver is controlled to output the electric power based on the PWM duty ratio computed based on the post-decay current, at the timing when the motor in which the current is detected is again the target motor in the cycle immediately following the cycle in which the current is detected.

This allows the motor to be controlled taking into account the effect of decay of the actual current value due to the electric power interruption to the target motor. As a result, the control quality can be improved.

It is preferable that when the current of the target motor is detected by the current detector, the motor driver is uniformly controlled to output the electric power based on the PWM duty ratio computed based on the current, at the timing when the motor in which the current is detected is again the target motor in the cycle immediately following the cycle in which the current is detected.

This allows for simplified processing.

In some motor systems as disclosed herein, the motor driver is controlled according to a predetermined output control cycle. In one cycle, time from a start to a stop of the electric power supply to one target motor includes a first output control cycle and a second output control cycle. In the first output control cycle, the motor driver outputs the electric power based on the PWM duty ratio computed based on the current, in a same cycle in which the current of the target motor is detected by the current detector. In the second output control cycle, the motor driver outputs the electric power based on the PWM duty ratio computed based on the current, in the cycle immediately following the cycle in which the current of the target motor is detected by the current detector.

This delays the output timing of the electric power based on the control to be the cycle immediately following, but only during a part of the period when the motor is the target motor. Thus, the controllability can be improved.

In some motor systems as described herein, the motor driver is controlled according to a predetermined output control cycle. The switcher switches the target motor at each predetermined switching cycle in each cycle. The output control cycle and the switching cycle are synchronized.

This enables a change in the control content synchronizing with the switching of the switcher.

### BRIEF DESCRIPTION OF THE DRAWINGS

FIG. 1 is a block diagram of a motor system according to one embodiment.

FIG. 2 is a graph illustrating the phenomenon of unintended operation of a motor when a motor driver is controlled in conjunction with switching of the target motor.

FIG. 3 is a graph illustrating a first example of the control.

FIG. 4 is a graph illustrating a second example of the control.

FIG. 5 is a graph illustrating a third example of the control.

FIG. 6 is a graph illustrating a fourth example of the control.

FIG. 7 is a diagram illustrating a prediction of current decay in the fourth example with reference to the current waveform of a first motor.

### DESCRIPTION OF THE REFERENCE NUMERALS

1 Motor system
21 Motor driver
22 Switcher
23 Motor
35 Current sensor (current detector)

### DETAILED DESCRIPTION

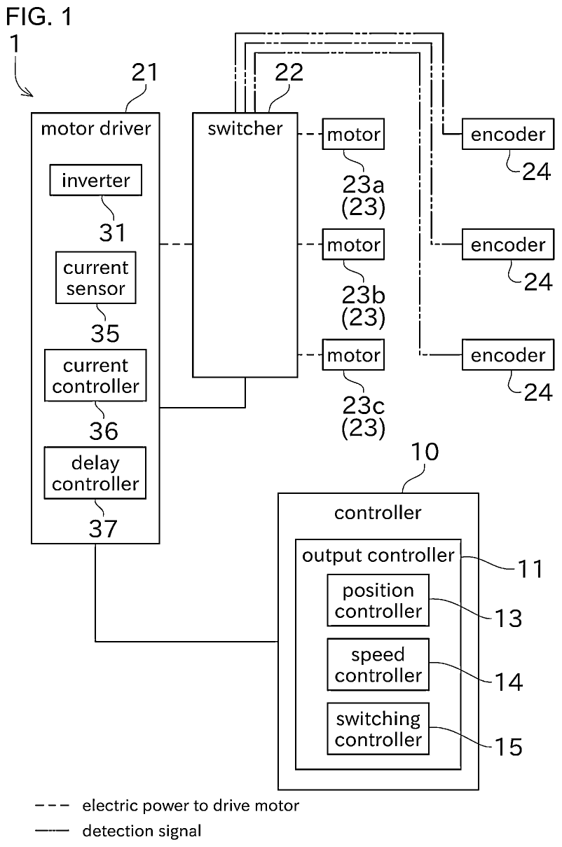

Next, our systems will be described with reference to the drawings. FIG. 1 is a block diagram of a motor system 1.

The motor system 1 is a system that controls a plurality of motors 23. As shown in FIG. 1, the motor system 1 includes a controller 10, a motor driver 21, a switcher 22, the plurality of motors 23, and a plurality of encoders 24.

The controller 10 controls the plurality of motors 23 via the motor driver 21 and the switcher 22. The configuration of the controller 10 is described below.

The motor driver 21 supplies electric power to the plurality of motors 23 to operate those motors 23. The motor driver 21 is, for example, a servo amplifier or an inverter. The motor driver 21 is electrically connected to the controller 10 and can send and receive signals.

The motor driver 21 is controlled by a driver control signal output by the controller 10. The motor driver 21 includes an inverter 31. The inverter 31 generates a drive waveform in response to the output of the controller 10. The motor driver 21 outputs a voltage based on the acquired drive waveform to the switcher 22. The detailed configuration of a current sensor 35 will be described later.

The motor driver 21 includes the current sensor (current detector) 35, a current controller 36 and a delay controller 37.

The current sensor 35 detects the magnitude of the current supplied from the motor driver 21 to the motor 23.

The current controller 36 controls the inverter 31 to generate the drive waveform for the motor 23 in response to a signal input from an output controller 11 described later, which is provided by the controller 10. Details of the current controller 36 will be described later.

The delay controller 37 delays, as appropriate, operation of a position controller 13 or a speed controller 14, etc., provided by the controller 10. Details of the delay control will be described later.

The switcher 22 selectively supplies the electric power output by the motor driver 21 to the plurality of motors 23. The switcher 22 is communicatively connected to the controller 10 via the motor driver 21 and can send and receive signals. The motor driver 21 and the switcher 22 are provided in a one-to-one correspondence. However, the motor driver 21 and the switcher 22 may correspond one-to-many or many-to-one instead of one-to-one.

The motor driver 21 is connected to an input side of the switcher 22. The plurality of motors 23 are connected to an output side of the switcher 22 respectively. The number of the motor 23 is arbitrary as long as there is the plurality of motors 23, but in this embodiment, there are three. Each of the three motors 23 may be referred to as a first motor 23a, a second motor 23b, and a third motor 23c to identify each of the three motors 23.

The switcher 22 is configured as a circuit containing a plurality of switches. The switcher 22 is implemented on a substrate, for example. Switching the switches included in the switcher 22 causes the motor 23 to which the electric power is supplied to be switched. The motor 23 to which the electric power is supplied may hereinafter be referred to as a target motor.

At a given moment, the target motor, which is the destination of the electric power supply, is only one of the plurality of motors 23 connected to the switcher 22, i.e., any of the first motor 23a, second motor 23b and third motor 23c. The switcher 22 repeats operation of cyclically switching the target motor among the three motors 23 at high speed. This allows the three motors 23 to be driven substantially simultaneously.

The switching operation of the switcher 22 is performed in such a way that the combination of a period during which the first motor 23a is the target motor, a period during which the second motor 23b is the target motor, and a period during which the third motor 23c is the target motor is one cycle, and this cycle is repeated. This causes the target motor to cyclically switch among the first motor 23a, the second motor 23b, and the third motor 23c.

Each of the motors 23 has a stationary element and a moving element. Preferably, any one of the stationary element and the moving element contains a permanent magnet and the other contains a coil. The coil becomes an electromagnet when the electric power is supplied to the coil from the motor driver 21. This causes a repulsive or attractive force between the stationary element and the moving element, resulting in relative motion of the moving element with respect to the stationary element. The motor 23 is a linear motor in which the moving element moves (slides) in a linear motion relative to the stationary element. A rotary motor in which the moving element (rotor) rotates with respect to the stationary element can also be used as the motor 23.

The motor 23 can be configured, for example, as a three-phase motor or a two-phase motor. The inverter 31 provided by the motor driver 21 includes a number of semiconductor switch elements corresponding to the number of phases of the motor. When a voltage command value is input to the inverter 31 from the current controller 36, the inverter 31 opens and closes the switch elements repeatedly at high speed according to a known PWM control to achieve a duty ratio corresponding to the voltage command value. This allows the motor driver 21 to generate the drive waveform to drive the three motors 23 by distributing the electric power to the three motors 23 in a time-slicing manner.

The encoder 24 detects an operating state of the motor 23, in particular a relative displacement of the moving element with respect to the stationary element.

If the motor 23 is a linear motor, the encoder 24 can be, for example, a magnetic sensor installed on a path of movement of the moving element. The magnetic sensor can detect a position of the moving element relative to the stationary element. If motor 23 is a rotary motor, the encoder 24 can be, for example, a known Hall element. The Hall element is capable of detecting an angle of rotation of the moving element.

The encoder 24 is electrically connected to the switcher 22 and can output a detection signal to the switcher 22. The detection result of the encoder 24 is transmitted to the controller 10 via the motor driver 21.

The controller 10 includes the output controller 11.

The controller 10 is configured as a known computer including, for example, a CPU, a ROM, a RAM, an auxiliary storage, and the like. The auxiliary storage is configured as, for example, an HDD, an SSD, or the like. The auxiliary storage stores various programs and other programs. By executing these programs, the controller 10 can perform various controls on the motor system 1. Thus, through the cooperation of hardware and software, the controller 10 can function as the output controller 11.

The controller 10 may perform processes other than the control described above. Some or all of the output controller 11 may be realized by hardware (for example, the motor driver 21) that is physically different from the controller 10.

The output controller 11 generates and transmits a driver control signal to the motor driver 21. The driver control signal is a signal of a current command output by the speed controller 14 described later. The motor driver 21 controls the duty ratio of the PWM control based on the current command and outputs electric power as the PWM from the inverter 31.

The output controller 11 includes the position controller 13, the speed controller 14, and a switching controller 15.

The position controller 13 has a function of controlling a position of the moving element for each of the motors 23. The position controller 13 compares, for example, the current position of the moving element detected by the encoder 24 with the target position of the moving element, and outputs a speed command to the speed controller 14 according to the position deviation.

The speed controller 14 has a function of controlling a speed of the moving element for each of the motors 23. The speed controller 14 compares, for example, the current speed based on the change in the position of the moving element detected by the encoder 24 with the speed command input from the position controller 13, and generates a current command corresponding to the speed deviation. The current command is a signal that indicates the current value. The current command corresponds to the output of the output controller 11. As will be described later in detail, this current command is input to the current controller 36 provided by the motor driver 21.

The switching controller 15 controls the output of the current commands generated by the speed controller 14 for each of the three motors 23 to the motor driver 21 while switching cyclically. This switching is performed in response to the switcher 22 cyclically switching the target motor among the three motors 23.

In relation to the output controller 11, operation of the current controller 36 provided by the motor driver 21 will be described. The current controller 36 determines the voltage command value of the PWM control for each motor 23.

The following is a detailed description focusing on the first motor 23a. The current controller 36 compares the current value acquired from the current sensor 35 with respect to the first motor 23a and the current command input from the motor system 1 (in other words, the speed controller 14 provided by the output controller 11), and computes the voltage to be applied to the coil of each phase of the first motor 23a in accordance with the current value deviation. This computation is based on, for example, known vector control. Thus, the current value acquired by the current sensor 35 is used for feedback control.

The current controller 36 similarly determines the voltage to be applied for the coils of each phase in the second motor 23b and the third motor 23c.

The current controller 36 generates and outputs PWM voltage command values based on the voltages acquired by the computation. In the case where the plurality of motors 23 are, for example, three-phase motors, the voltage command values are generated for each of the three phases.

In the controller 10, the output controller 11 operates at a constant cycle, resulting in a change in the current command. Hereafter, the cycle, which is the smallest unit of time in which the current command is controlled, may be referred to as the output control cycle. The output control cycle coincides with the control cycle in which the voltage command is controlled in the current controller 36 of the motor driver 21.

As described above, the voltage output by the motor driver 21 is selectively supplied to the first motor 23a, the second motor 23b, and the third motor 23c through the switcher 22, which repeats a cyclical switching operation. Correspondingly, the current command generated by the output controller 11 is a time-slicing composite of signals indicating current values for each of the first, second and third motors 23a, 23b and 23c, respectively.

The inverter provided by the motor driver 21 has the number of semiconductor switch elements corresponding to the number of phases of the motor 23. When a voltage command value is input to the inverter 31 from the current controller 36, the inverter 31 opens and closes the switch elements repeatedly at high speed according to a known PWM control to achieve a duty ratio corresponding to the voltage command value. This allows the motor driver 21 to generate a drive waveform to drive the three motors 23 by distributing the electric power to the three motors 23 in a time-divisional manner.

The output control cycle coincides with the carrier cycle of the PWM control performed by motor driver 21. This allows the motor driver 21 to acquire a voltage waveform for good realization of the current command output by the controller 10 by the PWM control and supply electric power to the switcher 22.

In one cycle of switching the target motor between three motors 23, the period during which electric power is supplied to one motor 23 is equal to the output control cycle or n times thereof (where n is an integer greater than or equal to 2). This enables switching of the drive waveform in conjunction with switching of the target motor.

With the above control, each of the three 23 motors can be driven in different directions and at different speeds.

The plurality of motors 23 correspond to one motor driver 21, and the switcher 22 switches so that electric power is distributed to the plurality of motors 23 in a time-slicing manner. This allows one motor driver 21 to drive substantially the plurality of motors 23 simultaneously. Therefore, the number of motor drivers 21 can be reduced compared to a configuration in which motor drivers 21 are provided individually for each of the motors 23a, 23b, and 23c. Similarly, the current sensor 35 is also provided so that it is common to the plurality of motors 23 to which electric power is distributed. Therefore, the number of current sensors 35 can be reduced. As a result, the installation cost of the motor system 1 can be reduced.

Next, the delay controller 37 provided by the motor driver 21 will be described in detail.

The output controller 11 provided by the controller 10 controls the motor driver 21 according to a predetermined output control cycle. Control of the motor driver 21 means, substantially, the PWM control of the voltage waveform output by the motor driver 21.

Feedback control of the current value via the duty ratio requires a series of processes from a first to a fourth process described below. (1) In the first process, the current sensor 35 detects the magnitude (current value) of the current flowing in the target motor. (2) In the second process, operation of the position controller 13 and the speed controller 14 of the output controller 11 causes the speed controller 14 to generate a current command, and this current command is output as a driver control signal from the controller 10 to the motor driver 21. (3) In the third process, the current controller 36 of the motor driver 21 computes a voltage value based on the current command and the detected value of the current sensor 35, and outputs the corresponding voltage command value to the inverter 31. (4) In the fourth process, the inverter 31 performs PWM control of the switch elements according to the duty ratio corresponding to the voltage command value.

The series of processes may hereinafter be referred to as a control process. Although the control process is performed at high speed by the controller 10 and the motor driver 21, a reasonable amount of time is required. For example, if the output control cycle is shortened to improve the accuracy of motor control, the time required for control process may be longer than the output control cycle.

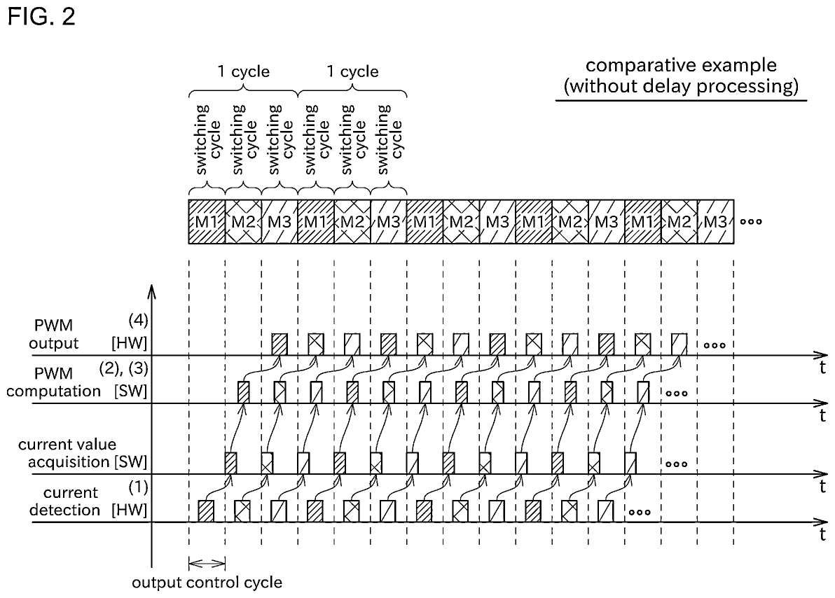

FIG. 2 shows a case in which the time that electric power is supplied to each of the three motors 23 in one cycle is all equivalent to one cycle of the output control cycle. In other words, at each output control cycle, the target motor is switched to another motor 23 among the three motors 23 by the switching operation of the switcher 22.

Hereafter, the cycle in which the switching operation is performed by the switcher 22 may be referred to as the switching cycle. The switching cycle can be defined to be equal for the three motors 23, or it can be defined to be different for each motor 23. In the case where the switching cycle is constant, the switching cycle multiplied by the number of the motors 23 corresponds to the period of one cycle.

The switching cycle is synchronized with the output control cycle of the output controller 11. Therefore, it is possible to prevent unintended operation of the motor 23 near the timing when the target motor is switched, with a simple configuration.

In the graph in FIG. 2, the horizontal axis is time. The interval of the dashed lines arranged in the horizontal direction corresponds to the output control cycle. As mentioned above, the output control cycle coincides with the carrier cycle of the PWM control. Rectangles M1, M2, and M3 drawn at the top of the graph indicate the periods when the first motor 23a, the second motor 23b, and the third motor 23c is the target motor, respectively. Since there are three motors 23 in this example, one cycle period corresponds to three output control cycles.

The vertical axis of the graph in FIG. 2 is labeled with the process performed to drive each of the three motors 23. In the labels on the vertical axis, SW is an abbreviation for software and HW is an abbreviation for hardware. The bracketed numbers attached to each label correspond to each of the first through fourth processes described above that the control process includes.

In the graph in FIG. 2, the control process is represented by four rectangles connected by arrows. The arrows connecting the four rectangles indicate that information flows from the upstream process to the downstream process. The hatching on the rectangles corresponds to the hatching on the rectangles M1, M2, and M3 at the top of the graph, indicating which of the three motors 23 the control process is for.

The control process starts every output control cycle. The graph in FIG. 2 shows a case where the time required for the motor driver 21 to drive the switch element at the appropriate duty ratio for the relevant motor 23 in the fourth process after the current sensor 35 acquires the current value of a certain motor 23 in the first process exceeds one output control cycle. In the example in FIG. 2, the fourth process lags behind the first process by two cycles of the output control cycle.

The following is an explanation focusing on the control process for the first motor 23a, which is shown on the leftmost side of the graph in FIG. 2. Even though the switch element of the motor driver 21 is turned on/off for the first motor 23a in the fourth process based on the current value of the first motor 23a detected in the first process, the switcher 22 is switched twice from the start of the first process to just before the fourth process. Therefore, at the timing when the fourth process is performed, the third motor 23c, which is different from the first motor 23a, is the target motor.

Thus, the current to drive the first motor 23a is supplied by the motor driver 21 to the third motor 23c as a result, causing unintended operation. The same applies to the control regarding the second motor 23b and the third motor 23c.

Considering above, the motor driver 21 is provided with the delay controller 37. In the course of the control process, the delay controller 37 controls the start of the second process, for example, so that the start of the second process is intentionally delayed by one cycle of the output control cycle uniformly. The delay can be achieved, for example, by an appropriate waiting process performed before the second process.

The third and fourth processes assume that the previous stage of processing has been completed. Therefore, as the second process is delayed, the start and end of the third and fourth processes are necessarily delayed as well.

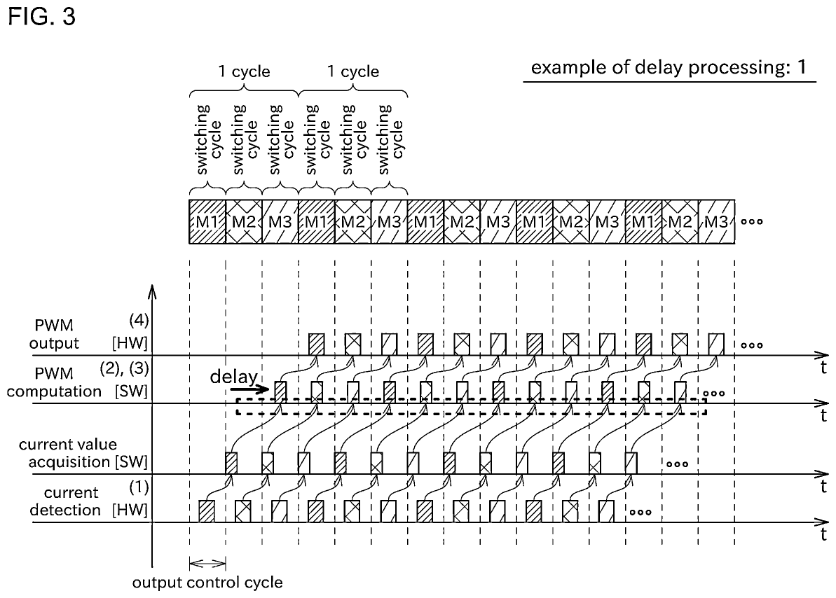

As a result of the delay control, as shown in FIG. 3, the fourth process is delayed relative to the first process by three output control cycles. Therefore, after the current value of the first motor 23a is obtained in the first process, by the time the motor driver 21 starts the PWM control for the first motor 23a in the fourth process, the switcher 22 has switched three times and the first motor 23a is again the target motor.

Thus, the delay controller 37 delays the control process so that the timing when the motor driver 21 performs the PWM control for the first motor 23a in the fourth process is included in the period when the first motor 23a is the target motor in the cycle immediately following the cycle to which the first process belongs. This allows the PWM control that the motor driver 21 performs for the first motor 23a to be correctly applied to the first motor 23a.

The time to delay the control process is not limited to one cycle of the output control cycle. The delay time can be determined according to the original time required for the control process, the length of the switching cycle, the number of the motors 23 to which the electric power of the motor driver 21 is distributed, etc.

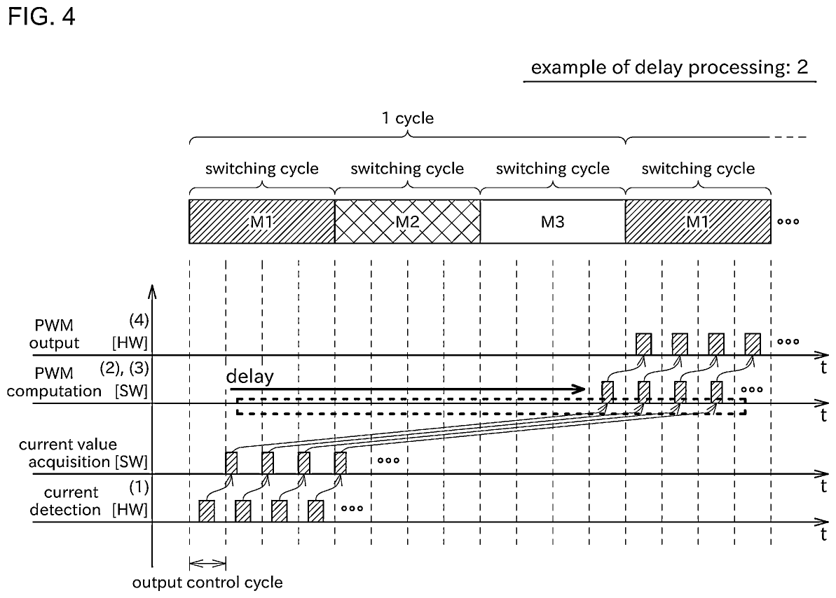

FIG. 4 shows a case in which the time that electric power is supplied to each of the three motors 23 in one cycle is all equal to four cycles of the output control cycle. The switching cycle is four cycles of the output control cycle. Since the number of the motors 23 is three, one cycle period corresponds to 12 cycles of the output control cycle.

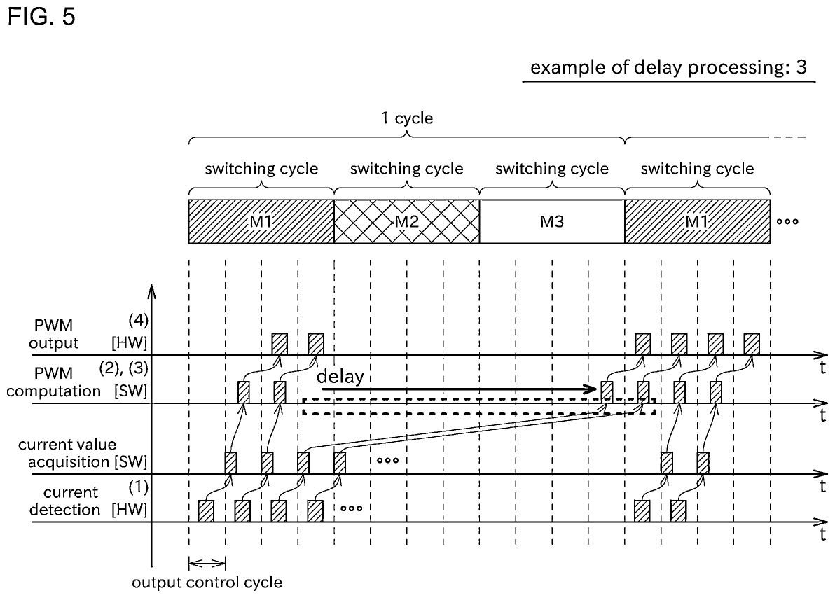

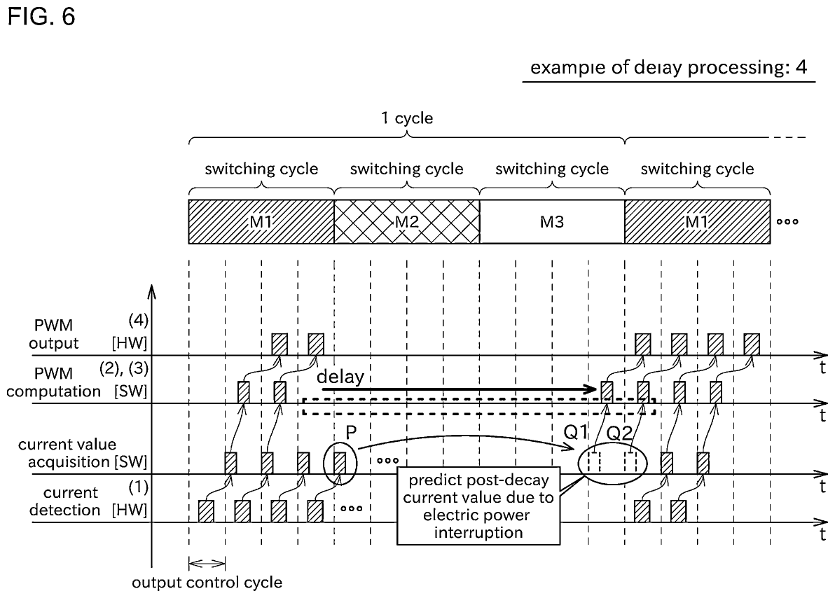

In the graph in FIG. 4, the control processes for the second motor 23b and the third motor 23c are omitted to avoid drawing complexity. The same is applied in FIG. 5 and FIG. 6.

In FIG. 4, for example, during the period when the first motor 23a is the target motor, the control process to drive the first motor 23a is started four times in total, once for each output control cycle. In the example in FIG. 4, the control process that starts every output control cycle is uniformly delayed by ten cycles of the output control cycle. This allows the timing at which the motor driver 21 performs the PWM control for the first motor 23a in the fourth process to be included in the period when the first motor 23a is the target motor in the cycle immediately following the cycle to which the first process belongs.

FIG. 5 shows a variation of the delay control of FIG. 4. In the example of FIG. 5, the control process to drive the first motor 23a is started four times during the period in which the first motor 23a is the target motor. The delay controller 37 performs the delay control only for two of the four control processes that are started at later times in time.

Unlike FIG. 3, in the example of FIG. 5, the switching cycle is longer than the original time required for the control process. Therefore, in the example of FIG. 5, the PWM control of the fourth process after the current acquisition of the first process is performed can be performed before the switching operation is performed by the switcher 22, even without performing delay control for the two times that start at a time earlier timing among the four control processes. Therefore, the delay controller 37 does not perform the delay control for these two control processes.

On the other hand, for the two control processes that start at later timing in time, the delay control is performed for eight cycles of the output control cycle. This allows the timing at which the motor driver 21 performs the PWM control for the first motor 23a in the fourth process to be included in the period when the first motor 23a is the target motor in the cycle immediately following the cycle to which the first process belongs.

In the example in FIG. 5, for the two control processes that start at later timing in time out of the four cycles, the post-decay current value in the period when the current is interrupted for motor 23 before the cycle becomes the next one can also be predicted. FIG. 6 is a schematic illustrating this example. When the delay control of FIG. 6 is performed, the output controller 11 in FIG. 1 includes a current decay predictor, which is not shown in the figure.

In the example of FIG. 6, the two control processes that start at later timing in time out of the four are delayed by eight cycles of the output control cycle, as in FIG. 5. However, the delayed third process (generation of the voltage command) is performed based on the predicted post-decay current value instead of the current value detected by the current sensor 35.

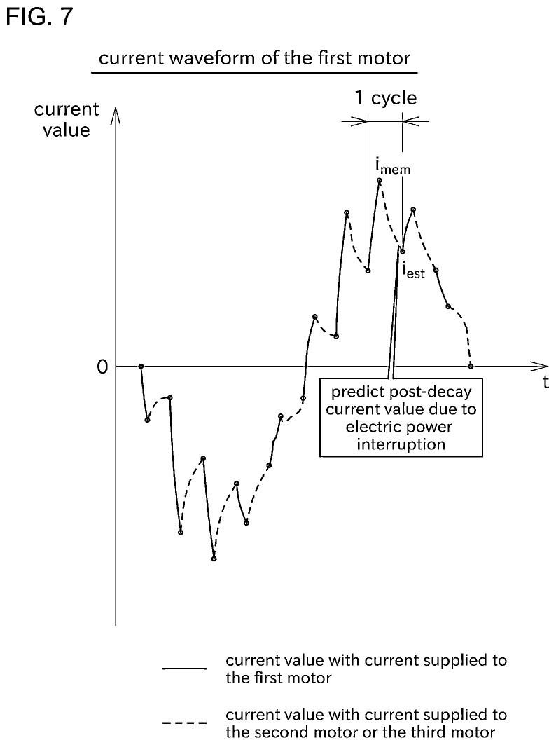

FIG. 7 shows an example of the current waveform of one of the coils of the first motor 23a, along with one cycle period. Each cycle period includes a period of time when the first motor 23a is the target motor and a period of time when the second motor 23b or third motor 23c is the target motor. The first motor 23a is supplied with electric power only during the period when the first motor 23a is the target motor, and the electric power supply is interrupted during other periods. During the periods when electric power is not supplied, the current decays to approach zero. Therefore, the current waveform of the first motor 23a is a composite of a sine wave and a sawtooth wave, as shown in the graph in FIG. 7. In the waveform of FIG. 7, the portion corresponding to the period when electric power is supplied to the first motor 23a is shown by a solid line, and the portion corresponding to the period when the power supply is interrupted is shown by a dashed line.

Similarly, the current sensor 35 can only detect the current value of the first motor 23a during the period when the first motor 23a is the target motor, and cannot detect the current value during other periods.

When performing the delay control, the delay controller 37 stores the latest current value acquired just before the target motor is switched from the first motor 23a to another motor. The sign P in FIG. 6 indicates the control process performed at the latest timing for the first motor 23a in a certain cycle, which is the process of acquiring the current. The current value acquired in the process indicated by this sign P is stored in an appropriate memory device of the motor driver 21. This current value can be, substantially, the current value immediately before the electric power to the first motor 23a is interrupted. An example of a stored current value is indicated by iₘₑₘ in the graph in FIG. 7.

In the next cycle, the process of predicting the current value after the above mentioned decay is performed for the first motor 23a, based on the current value iₘₑₘ stored earlier. In FIG. 6, this prediction process is indicated by dashed rectangles with the signs Q1 and Q2. An example of the predicted current values is shown by iₑₛₜ in the graph in FIG. 7.

The post-decay current value iₑₛₜ is represented by the following equation, where iₘₑₘ is the stored current value, t is the elapsed time after electric power interruption, and T is the time constant.

$${i}_{est} = {i}_{mem} \times {e}^{\frac{- t}{T}}$$

The time constant T is determined based on the resistance and inductance of the motor 23 and is stored in the motor driver 21 in advance. When predicting the post-decay current value at the time of process Q1 in FIG. 6, the elapsed time t after electric power interruption is constant throughout all cycles. The same is applied for predicting the post-decay current value at the time of process Q2. Therefore, it is preferable to calculate the value of the exponential function part of the above equation for each of the timings of process Q1 and Q2 in advance and store it as a constant. Although the computation load of the exponential function is generally high, the estimated post-decay current value, iₑₛₜ, can be acquired simply by multiplying the stored current value, iₘₑₘ, by the constant.

In the example of FIG. 6, each of the motors 23 can be controlled based on the current value closer to the actual value than in the example of FIG. 5. The process of predicting the post-decay current value from the current value of the previous cycle can also be applied to the delay control shown in FIG. 3 or FIG. 4.

As explained above, the motor system 1 has the plurality of motors 23, the motor driver 21, the current sensor 35, the switcher 22, and the output controller 11. The motor driver 21 outputs electric power to make the plurality of motors 23 generate driving force. The current sensor 35 detects the current of the motors 23. The switcher 22 switches selectively the target motor, which is the target to be supplied with the electric power output by the motor driver 21 and the target to be detected for the current by the current sensor 35, among the plurality of motors 23. The PWM duty ratio to drive the target motor is computed based on the current detected by the current sensor 35, and the motor driver 21 is controlled to output the electric power based on this PWM duty ratio. The switcher 22 cyclically switches the target motor among the plurality of motors 23. When the current of the target motor is detected by the current sensor 35, the motor driver 21 is controlled to output the electric power based on the PWM duty ratio computed based on the current, at a timing when the motor 23 in which the current is detected is again the target motor in a cycle after the cycle in which the current is detected.

This allows one motor driver 21 to drive the plurality of motors 23 substantially simultaneously and control the output for each motor 23 individually. The output of one motor driver 21 can be cyclically switched among the plurality of motors 23 while the control to each motor 23 can be correctly applied to the relevant motor 23. Since the motor driver 21 and current sensor 35 can be shared among the plurality of motors 23, the configuration can be simplified.

In the motor system 1, when the current of the target motor is detected by the current sensor 35, the motor driver 21 is controlled to output the electric power based on the PWM duty ratio computed based on the current, at the timing when the motor 23 in which the current is detected is again the target motor in the cycle immediately following the cycle in which the current is detected.

This avoids controlling the target motor based on detection value corresponding to a different motor.

In the example of FIG. 6, when the current of the target motor is detected by the current sensor 35, based on the current, the output controller 11 computes the post-decay current to predict the decay due to the electric power interruption period that occurs before the motor 23 becomes the target motor again in the cycle immediately following the cycle in which the current is detected. The motor driver 21 is controlled to output the electric power based on the PWM duty ratio based on the post-decay current, at the timing when the motor 23 in which the current is detected is again the target motor in the cycle immediately following the cycle in which the current is detected.

This allows the motor 23 to be controlled taking into account the effect of decay of the actual current value due to the of electric power interruption to the target motor. As a result, the control quality can be improved.

In the example of FIG. 3 and FIG. 4, when the current of the target motor is detected by the current sensor 35, the motor driver 21 is uniformly controlled to output the electric power based on the PWM duty ratio computed based on the current, at the timing when the motor 23 in which the current is detected is again the target motor in the cycle immediately following the cycle in which the current is detected.

This allows for simplified processing.

In the example of FIG. 5 or FIG. 6, the motor driver 21 is controlled according to a predetermined output control cycle. The time from the start to the stop of the electric power supply to one target motor in one cycle is four cycles of the output control cycle. These four cycles are divided into two cycles that are ahead in time (the first output control cycle) and two cycles that are behind in time (the second output control cycle). In each of the former two cycles, the motor driver 21 outputs the electric power based on the PWM duty ratio computed based on the current, in the same cycle in which the current of the target motor is detected by the current sensor 35. In each of the latter two cycles, the motor driver 21 outputs the electric power based on the PWM duty ratio computed based on the current, in the cycle immediately following the cycle in which the current of the target motor is detected by the current sensor 35.

This delays the output timing of the electric power based on the control to be the cycle immediately following, but only during a part of the period when the motor 23 is the target motor. Thus, the controllability can be improved.

In the motor system 1, the switcher 22 switches the target motor at each predetermined switching cycle in each cycle. The output control cycle and the switching cycle are synchronized.

This enables a change in the control content synchronizing with the switching of the switcher 22.

While suitable embodiments of our systems have been described above, the above configuration can be modified, for example, as follows. The changes may be made independently or in any combination of several changes.

The delay controller 37 may control the motor driver 21 so that when the current of the target motor is detected by the current sensor 35, the motor driver 21 outputs the electric power based on the PWM duty ratio computed based on the current, in two cycles after the cycle in which the current is detected, or in a subsequent cycle.

The delay is not limited to targeting the second process of the control process, but can also target the third or fourth process, for example. The delay controller 37 may be provided in the output controller 11.

The length of the switching cycle can be set according to a number of cycles of the output control cycle as appropriate.

The motor driver 21 and the switcher 22 may be realized in physically separate devices or in one device.

From the above described embodiments and variations thereof, at least the following technical ideas can be grasped.

Item 1: A motor system including:
a plurality of motors;
a motor driver that outputs electric power to make the plurality of motors generate driving force;
a current detector that detects a current of a motor; and
a switcher that selectively switches a target motor, which is a target to be supplied with the electric power output by the motor driver and a target to be detected for the current by the current detector, among the plurality of motors, wherein
a PWM duty ratio to drive the target motor is computed based on the current detected by the current detector,
the motor driver is controlled to output the electric power based on the PWM duty ratio,
the switcher cyclically switches the target motor among the plurality of motors, and
when the current of the target motor is detected by the current detector, the motor driver is controlled to output the electric power based on the PWM duty ratio computed based on the current, at a timing when the motor in which the current is detected is again the target motor, in a cycle after the cycle in which the current is detected.

Item 2: The motor system according to item 1, wherein
when the current of the target motor is detected by the current detector, the motor driver is controlled to output the electric power based on the PWM duty ratio computed based on the current, at a timing when the motor in which the current is detected is again the target motor, in a cycle immediately following the cycle in which the current is detected.

Item 3: The motor system according to item 2, wherein
when the current of the target motor is detected by the current detector, based on the current, a post-decay current is computed by a prediction of decay due to an electric power interruption period that occurs before the motor becomes the target motor again in the cycle immediately following the cycle in which the current is detected, and
the motor driver is controlled to output electric power based on the PWM duty ratio computed based on the post-decay current, at the timing when the motor in which the current is detected is again the target motor, in the cycle immediately following the cycle in which the current is detected.

Item 4: The motor system according to item 2 or 3, wherein
when the current of the target motor is detected by the current detector, the motor driver is uniformly controlled to output electric power based on the PWM duty ratio computed based on the current, at the timing when the motor in which the current is detected is again the target motor, in the cycle immediately following the cycle in which the current is detected.

Item 5: The motor system according to item 2 or 3, wherein
the motor driver is controlled according to a predetermined output control cycle, and
in one the cycle, time from a start to a stop of electric power supply to one the target motor includes:
a first output control cycle in which the motor driver outputs electric power based on the PWM duty ratio computed based on the current, in a same cycle in which the current of the target motor is detected by the current detector; and
a second output control cycle in which the motor driver outputs electric power based on the PWM duty ratio computed based on the current, in the cycle immediately following the cycle in which the current of the target motor is detected by the current detector.

Item 6: The motor system according to any of item 1 to 5, wherein
the motor driver is controlled according to a predetermined output control cycle,
the switcher switches the target motor at each predetermined switching cycle in each cycle, and
the output control cycle and the switching cycle are synchronized.

1. A motor system comprising:
a plurality of motors,
a motor driver that outputs electric power to make the plurality of motors generate driving force;
a current detector that detects a current of a motor; and
a switcher that selectively switches a target motor, which is a target to be supplied with an electric power output by the motor driver and a target to be detected for the current by the current detector, among the plurality of motors, wherein
a PWM duty ratio to drive the target motor is computed based on the current detected by the current detector,
the motor driver is controlled to output the electric power based on the PWM duty ratio,
the switcher cyclically switches the target motor among the plurality of motors, and
when the current of the target motor is detected by the current detector, the motor driver is controlled to output the electric power based on the PWM duty ratio computed based on the current, at a timing when the motor in which the current is detected is again the target motor in a cycle after the cycle in which the current is detected.

2. The motor system according to claim 1, wherein when the current of the target motor is detected by the current detector, the motor driver is controlled to output the electric power based on the PWM duty ratio computed based on the current, at a timing when the motor in which the current is detected is again the target motor in a cycle immediately following the cycle in which the current is detected.

3. The motor system according to claim 2, wherein
when the current of the target motor is detected by the current detector, based on the current, a post-decay current is computed by a prediction of decay due to an electric power interruption period that occurs before the motor becomes the target motor again in the cycle immediately following the cycle in which the current is detected, and
the motor driver is controlled to output the electric power based on the PWM duty ratio computed based on the post-decay current, at the timing when the motor in which the current is detected is again the target motor in the cycle immediately following the cycle in which the current is detected.

4. The motor system according to claim 2, wherein when the current of the target motor is detected by the current detector, the motor driver is uniformly controlled to output the electric power based on the PWM duty ratio computed based on the current, at the timing when the motor in which the current is detected is again the target motor in the cycle immediately following the cycle in which the current is detected.

5. The motor system according to claim 2, wherein
the motor driver is controlled according to a predetermined output control cycle, and
in one cycle, time from a start to a stop of the electric power supply to one target motor includes:
a first output control cycle in which the motor driver outputs the electric power based on the PWM duty ratio computed based on the current, in a same cycle in which the current of the target motor is detected by the current detector; and
a second output control cycle in which the motor driver outputs the electric power based on the PWM duty ratio computed based on the current, in the cycle immediately following the cycle in which the current of the target motor is detected by the current detector.

6. The motor system according to claim 1, wherein
the motor driver is controlled according to a predetermined output control cycle,
the switcher switches the target motor at each predetermined switching cycle in each cycle, and
the output control cycle and the switching cycle are synchronized.
